(19) United States
(12) Patent Application Publication
(10) Pub. No.: US 2013/0188578 A1
(43) Pub. Date: Jul. 25, 2013

(54) HIGH CAPACITY WIRELESS COMMUNICATIONS SYSTEM

(71) Applicant: QUALCOMM Incorporated, San Diego, CA (US)

(72) Inventors: Assaf Touboul, Ra'anana (IL); Raphael E. Cohen, Ra'anana (IL); Maxim Gotman, Ra'anana (IL)

(73) Assignee: QUALCOMM INCORPORATED, San Diego, CA (US)

(21) Appl. No.: 13/747,093

(22) Filed: Jan. 22, 2013

Related U.S. Application Data
(60) Provisional application No. 61/589,407, filed on Jan. 23, 2012.

(51) Int. Cl. H04W 72/04

(52) U.S. Cl. CPC H04W 72/04
USPC 370/329

(57) ABSTRACT

Methods, systems, and apparatuses are described for wirelessly communicating at a multi-mode wireless modem. In accordance with a disclosed method, a single carrier wireless channel may be selected from one of a line of sight (LOS) band or a non-line of sight (NLOS) band for receiving an incoming cyclically prefixed single carrier signal. The modem may be capable of receiving signals over both the LOS band and the NLOS band. A cyclic prefix length associated with the incoming single carrier signal may be tuned based on an estimated delay spread of the selected single carrier wireless channel. A cyclic prefix of the cyclic prefix length may be identified and removed from the incoming single carrier signal over the selected single carrier wireless channel. Frequency domain equalization on the incoming single carrier signal may be performed following the removal of the cyclic prefix.

### CROSS REFERENCES

The present application for patent claims priority benefit to U.S. Provisional Patent Application No. 61/589,407, entitled “High Capacity Wireless Communications System” by Touboul et al., filed Jan. 23, 2012, assigned to the assignee hereof, and expressly incorporated by reference herein.

### BACKGROUND

In modern communications systems, the Multiple-In-Multiple-Out Spatial Multiplexing (MIMO SM) technique has been widely adopted for achieving increased link capacity. In MIMO SM, a transmitter transmits K≧2 independent data streams over the same time-frequency resources, separating the streams in space and/or by polarization (when K=T=2), exploiting T>K transmit antennas to reach R≧T antennas in the receiver. This approach may allow up to a K-fold increase in the link capacity with respect to the single stream approach, at the expense of increased hardware cost and of a more complex receiver. Examples of systems exploiting MIMO SM techniques include, but are not limited to, WiMAX® Matrix B scheme, LTE® SM-MIMO transmit mode, cross-polarization interference cancellation (XPIC) transceivers used in microwave point-to-(multi)point communications where spatial multiplexing is enhanced using cross-polarization discrimination (XPD) between the antennas, etc.

Traditionally, communications systems designed for non-line of sight (NLOS) operation over frequency selective fading channels, with relatively long delay spreads, exploit orthogonal frequency division multiplex (OFDM) modulation. While demonstrating good properties combating fading channels, OFDM can have several drawbacks, including low spectral efficiency, high peak-to-average-power ratio (PAPR), expensive components, and susceptibility to phase noise. For these reasons, single carrier modulation schemes are typically chosen for high capacity point-to-point line of sight (LOS) microwave communications with high levels of phase noise. Whereas OFDM receivers are typically frequency domain based, single carrier MIMO SM receivers are traditionally time domain based. Consequently, different baseband modems are typically used for OFDM MIMO receivers and single carrier MIMO receivers.

Because of these differences between OFDM and single-carrier based MIMO schemes, traditional wireless devices implementing both NLOS and LOS communications typically employ separate baseband modems with different hardware platform designs for different frequency bands. The use of separate hardware platforms for the different bands may be costly and reduce manufacturing, distribution, management, and support efficiencies.

### SUMMARY

The present disclosure generally relates to one or more improved methods, systems, and/or apparatuses for wirelessly communicating at a multi-mode wireless modem.

In accordance with a first set of illustrative embodiments, a disclosed method may include selecting a wireless channel from one of a line of sight (LOS) band or a non-line of sight (NLOS) band for receiving an incoming cyclically prefixed single carrier signal. The modem may be capable of receiving signals over both the LOS band and the NLOS band. A cyclic prefix length associated with the incoming single carrier signal may be tuned based on an estimated delay spread of the selected single carrier wireless channel. A cyclic prefix of the cyclic prefix length may be identified and removed from the incoming single carrier signal over the selected single carrier wireless channel. Frequency domain equalization on the incoming single carrier signal may be performed following the removal of the cyclic prefix.

In certain examples, phase noise suppression may be performed on the incoming single carrier signal in a time domain following the frequency domain equalization. For example, a phase error in the frequency equalized incoming single carrier signal may be detected using a time domain phase locked loop following the frequency domain equalization. This detected phase error may be used to rotate a carrier frequency offset originated phase of the incoming single carrier signal before performing the frequency domain equalization in a receive pipeline. In certain examples, the frequency domain equalization may be performed on a block-by-block basis, the equalized blocks may be transformed to the time domain, and the phase noise may be suppressed in the incoming single carrier signal on a sample-by-sample basis.

In certain examples, frequency domain equalization coefficients may be determined for the incoming single carrier signal based at least in part on a pilot sequence of a preamble of the incoming single carrier signal.

In certain examples, a sample time offset associated with the incoming single carrier signal may be determined in the frequency domain, and a sample time associated with the incoming single carrier signal may be adjusted in the time domain based at least in part on the sample time offset. A Fast Fourier Transform window or block size associated with frequency domain processing of the incoming single carrier signal may be selected based at least in part on the sample time offset.

In certain examples, the frequency domain equalization may be performed by a single-tap frequency domain equalization circuit. In certain examples, the estimated delay spread used to tune the cyclic prefix length associated with the incoming single carrier signal may include a maximum estimated delay spread associated with the selected wireless channel.

In certain examples, the NLOS band may include microwave carrier frequencies less than 6 GHz. Additionally or alternatively, the LOS band may include carrier frequencies greater than 6 GHz.

In accordance with a second set of illustrative embodiments, a disclosed multi-mode wireless modem may include a channel selection module, a cyclic prefix tuning module, a cyclic prefix removal module, and a frequency domain equalization module. The channel selection module may be configured to select a wireless channel from one of a line of sight (LOS) band or a non-line of sight (NLOS) band for receiving an incoming cyclically prefixed single carrier signal, wherein the modem is capable of receiving signals over both the LOS band and the NLOS band. The cyclic prefix tuning module may be configured to tune a cyclic prefix length associated with the incoming single carrier signal based on an estimated delay spread of the selected wireless channel. The cyclic prefix removal module may be configured to identify and remove a cyclic prefix of the cyclic prefix length from the incoming single carrier signal received over the selected channel. The frequency domain equalization module may be configured to perform frequency domain equalization on the incoming single carrier signal following the removal of the cyclic prefix.

In certain examples, the multi-mode wireless modem may further include a phase noise suppression module configured to perform phase noise suppression on the incoming single carrier signal in a time domain following the frequency domain equalization. The phase suppression module may further include a time domain phase locked loop, and the phase noise suppression module may be configured to detect a phase error in the incoming single carrier signal following the frequency domain equalization and a transformation to the time domain using the time domain phase locked loop.

In certain examples, the multi-mode wireless modem may include phase rotator circuitry configured to receive at least a portion of the detected phase error. The phase rotator circuitry may be disposed before the frequency domain equalization module in a receive pipeline. Inverse Fast Fourier Transform (IFFT) circuitry may be disposed between the frequency domain equalization module and the phase noise suppression module. The IFFT circuitry may be configured to transform the frequency equalized incoming single carrier signal into the time domain. The frequency domain equalization module may be further configured to perform the frequency domain equalization on a block-by-block basis, and the phase noise suppression module may be further configured to suppress the phase noise in a time domain version of the frequency equalized incoming single carrier signal on a sample-by-sample basis.

In certain examples, the frequency domain equalization module may be further configured to determine frequency domain equalization coefficients for the incoming single carrier signal based at least in part on a pilot sequence of a preamble of the incoming single carrier signal. The frequency domain equalization module may include a single-tap frequency domain equalization circuit configured to perform the frequency domain equalization. In certain examples, the estimated delay spread used to tune the cyclic prefix length associated with the incoming single carrier signal may include a maximum estimated delay spread associated with the selected wireless channel.

In certain examples, the NLOS band may include microwave carrier frequencies less than 6 GHz. Additionally or alternatively, the LOS band may include carrier frequencies greater than 6 GHz.

In accordance with a third set of illustrative embodiments, a disclosed apparatus for receiving multi-mode wireless signals may include: means for selecting a wireless channel from one of a line of sight (LOS) band or a non-line of sight (NLOS) band for receiving an incoming cyclically prefixed single carrier signal, wherein the modem is capable of receiving signals over both the LOS band and the NLOS band; means for tuning a cyclic prefix length associated with the incoming single carrier signal based on an estimated delay spread of the selected single carrier wireless channel; means for identifying and removing a cyclic prefix of the cyclic prefix length from the incoming single carrier signal; and means for performing frequency domain equalization on the incoming single carrier signal following the removal of the cyclic prefix.

In certain examples, the apparatus may include means for performing phase noise suppression on the incoming single carrier signal in a time domain following the means for performing frequency domain equalization in a receive pipeline. The means for performing phase noise suppression may include means for detecting a phase error in the frequency equalized incoming single carrier signal using a time domain phase locked loop.

In certain examples, the apparatus may further include means for outputting the detected phase error to phase rotator circuitry disposed before the means for performing frequency domain equalization in the receive pipeline. The apparatus may additionally include means for performing the frequency domain equalization on a block-by-block basis; and means for suppressing the phase noise in the incoming single carrier signal on a sample-by-sample basis.

In certain examples, the apparatus may include means for determining frequency domain equalization coefficients for the incoming single carrier signal based at least in part on a pilot sequence of a preamble of the incoming single carrier signal.

In certain examples, the apparatus may further include means for determining a sample time offset associated with the incoming single carrier signal in the frequency domain; and means for adjusting a sample time associated with the incoming single carrier signal in the time domain based at least in part on the sample time offset. The apparatus may include means for selecting a Fast Fourier Transform window size associated with frequency domain processing of the incoming single carrier signal based at least in part on the sample time offset.

In certain examples, the frequency domain equalization may be performed by single-tap frequency domain equalization circuit. In certain examples, the estimated delay spread used to tune the cyclic prefix of the incoming single carrier signal may be a maximum estimated delay spread associated with the selected wireless channel. In certain examples, the NLOS band may include microwave carrier frequencies below 6 GHz. Additionally or alternatively, the LOS band may include carrier frequencies above 6 GHz.

In accordance with a fourth set of illustrative embodiments, a disclosed computer program product for wirelessly communicating at a multi-mode wireless modem may include a computer-readable storage device having computer-readable program code stored thereon. The computer-readable program code may include: computer-readable program code configured to cause at least one processor to select a single carrier wireless channel from one of a line of sight (LOS) band or a non-line of sight (NLOS) band for receiving an incoming cyclically prefixed single carrier signal, wherein the multi-mode wireless modem is capable of receiving signals over both the LOS band and the NLOS band; computer-readable program code configured to cause the at least one processor to select a cyclic prefix length associated with the incoming single carrier signal for a tunable cyclic prefix module of the multi-mode wireless modem based on an estimated delay spread of the selected wireless channel; computer-readable program code configured to cause the at least one processor to identify and remove a cyclic prefix of the cyclic prefix length from the incoming single carrier signal; and computer-readable program code configured to cause the at least one processor to perform frequency domain equalization on the incoming single carrier signal following the removal of the cyclic prefix.

Further scope of the applicability of the described methods and apparatuses will become apparent from the following detailed description, claims, and drawings. The detailed description and specific examples are given by way of illustration only, since various changes and modifications within the spirit and scope of the description will become apparent to those skilled in the art.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 shows a block diagram of an example of a wireless communications system;

FIG. 2 shows a block diagram of another example of a wireless communications system;

FIG. 3 shows a block diagram of an example of a wireless communications device that may be configured for wireless communications in accordance with various embodiments;

FIG. 4 shows a block diagram of an example of first and second base stations capable of communicating via a cyclic single carrier (CSC) transmit/receive pipeline in accordance with various embodiments;

FIG. 5 shows a block diagram of an example of a Single-In-Single-Out (SISO) receive pipeline in accordance with various embodiments;

FIG. 6 shows an example of how an example Dual SISO receive pipeline in accordance with various embodiments;

FIG. 7 shows a block diagram of an example of an XPIC receive pipeline in accordance with various embodiments;

FIG. 8 shows a block diagram of an example of a MIMO communications system including first and second base stations;

FIGS. 9A, 9B & 9C show various examples of advanced link topologies that are capable of being supported with a single configurable or programmable CSC based system;

FIG. 10 is a flow chart illustrating one example of a method of wireless communication at a multi-mode wireless modem; and

FIG. 11 is a flowchart illustrating one example of a more detailed implementation of the method shown in FIG. 10.

### DETAILED DESCRIPTION

Wireless communications at a multi-mode wireless modem that may implement high capacity point-to-point, relay and point-to-multipoint links on any frequency band using a single configurable or programmable modem architecture are described. The disclosed methods, systems, and apparatuses propose a single modem architecture providing multipath robustness across lower frequencies (e.g., NLOS bands below 6 GHz) on the one hand, and robustness against phase noise and reduced PAPR across higher carrier frequencies(e.g., LOS microwave or millimeter-wave carrier frequencies above 6 GHz), by providing a flexible Cyclic Prefix-Single Carrier (CSC) physical (PHY) layer design and a mixed Frequency Domain-Time Domain (FD-TD) receiver architecture. In the disclosed methods, systems, and apparatuses, equalization may be performed partly in the frequency domain and partly in the time domain, and phase noise suppression may be performed in the time domain following equalization.

The disclosed methods, systems, and apparatuses may utilize CSC to provide a unified modem implementation regardless of the carrier frequency, enabling various advanced link topologies. A wireless telecommunications system implementing single carrier transmission with the addition of a cyclic prefix (CP) may provide inter-symbol interference (ISI)-free reception after CP removal, enabling single-tap frequency domain equalization, and avoiding the utilization of a time-domain equalization, which is inherently power consuming, more complex, and hard-limited in maximum delay spread supported.

Tuning or optimizing the CP length according to the typical channel characteristics across a given frequency band may allow the wireless link to reach OFDM-like robustness against multipath, while keeping the characteristics of single carrier transmission in terms of robustness against phase noise and PAPR.

CSC modulation may offer various features in comparison to OFDM. For example, CSC may offer a lower PAPR, identical to any other pure single carrier scheme, and robustness against phase noise, while not suffering from Inter-Carrier Interference (ICI) penalty due to loss of orthogonality between sub-carriers caused by receiver radio impairments.

On the other hand, the CP insertion may yield the same flexibility and multipath robustness as OFDM. The CP length can be increased to exceed the channel delay spread in order to guarantee ISI-free symbols for equalization.

Techniques described herein may be used for various wireless communications systems such as cellular wireless systems, Peer-to-Peer wireless communications, wireless local access networks (WLANs), ad hoc networks, satellite communications systems, and other systems. The terms “system” and “network” are often used interchangeably. These wireless communications systems may employ a variety of radio communication technologies such as Code Division Multiple Access (CDMA), Time Division Multiple Access (TDMA), Frequency Division Multiple Access (FDMA), Orthogonal FDMA (OFDMA), Single-Carrier FDMA (SC-FDMA), and/or other radio technologies. Generally, wireless communications are conducted according to a standardized implementation of one or more radio communication technologies called a Radio Access Technology (RAT). A wireless communications system or network that implements a Radio Access Technology may be called a Radio Access Network (RAN).

Examples of Radio Access Technologies employing CDMA techniques include CDMA2000, Universal Terrestrial Radio Access (UTRA), etc. CDMA2000 covers IS-2000, IS-95, and IS-856 standards. IS-2000 Releases 0 and A are commonly referred to as CDMA2000 1X, 1X, etc. IS-856 (TIA-856) is commonly referred to as CDMA2000 1xEV-DO, High Rate Packet Data (HRPD), etc. UTRA includes Wideband CDMA (WCDMA) and other variants of CDMA. Examples of TDMA systems include various implementations of Global System for Mobile Communications (GSM). Examples of Radio Access Technologies employing OFDM and/or OFDMA include Ultra Mobile Broadband (UMB), Evolved UTRA (E-UTRA), IEEE 802.11 (Wi-Fi), IEEE 802.16 (WiMAX), IEEE 802.20, Flash-OFDM, etc. UTRA and E-UTRA are part of Universal Mobile Telecommunications system (UMTS). 3GPP Long Term Evolution (LTE) and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies.

Thus, the following description provides examples, and is not limiting of the scope, applicability, or configuration set forth in the claims. Changes may be made in the function and arrangement of elements discussed without departing from the spirit and scope of the disclosure. Various embodiments may omit, substitute, or add various procedures or components as appropriate. For instance, the methods described may be performed in an order different from that described, and various steps may be added, omitted, or combined. Also, features described with respect to certain embodiments may be combined in other embodiments.

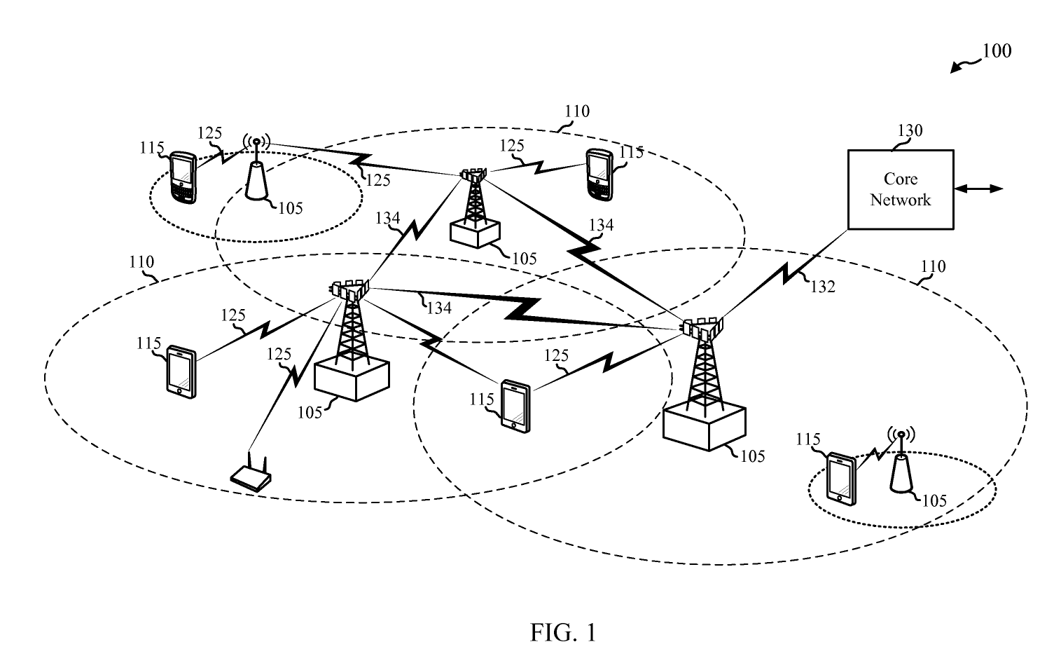

Referring first to FIG. 1, a diagram illustrates an example of a wireless communications system 100. The system 100 includes base stations (or cells) 105, communication devices 115, and a core network 130. The base stations 105 may communicate with the communication devices 115 under the control of a base station controller (not shown), which may be part of the core network 130 or the base stations 105 in various embodiments. Base stations 105 may communicate control information and/or user data with the core network 130 through wired or wireless backhaul links 132. In embodiments, the base stations 105 may communicate, either directly or indirectly, with each other over backhaul links 134, which may be wired or wireless communication links. The system 100 may support operation on multiple carriers (waveform signals of different frequencies). Multi-carrier transmitters can transmit modulated signals simultaneously on the multiple carriers. For example, each communication link 125 may be a multi-carrier signal modulated according to the various radio technologies described above. Each modulated signal may be sent on a different carrier and may carry control information (e.g., reference signals, control channels, etc.), overhead information, data, etc. In some embodiments, each of the base stations 105 may include a multi-mode wireless modem (or multiple multi-mode wireless modems) for communicating with one or more other base stations 105 via the wireless backhaul links 132 or 134.

The base stations 105 may wirelessly communicate with the devices 115 via one or more base station antennas. Each of the base station 105 sites may provide communication coverage for a respective geographic area 110. In some embodiments, a base station 105 may be referred to as a base transceiver station, a radio base station, an access point, a radio transceiver, a basic service set (BSS), an extended service set (ESS), a NodeB, eNodeB (eNB), Home NodeB, a Home eNodeB, or some other suitable terminology. The coverage area 110 for a base station may be divided into sectors making up only a portion of the coverage area (not shown). The system 100 may include base stations 105 of different types (e.g., macro, micro, and/or pico base stations). There may be overlapping coverage areas for different technologies.

In embodiments, the system 100 is an LTE/LTE-A network. In LTE/LTE-A networks, the terms evolved Node B (eNB) and user equipment (UE) may be generally used to describe the base stations 105 and devices 115, respectively. The system 100 may be a

Heterogeneous LTE/LTE-A network in which different types of eNBs provide coverage for various geographical regions. For example, each eNB 105 may provide communication coverage for a macro cell, a pico cell, a femto cell, and/or other types of cell. A macro cell generally covers a relatively large geographic area (e.g., several kilometers in radius) and may allow unrestricted access by UEs with service subscriptions with the network provider.

A pico cell would generally cover a relatively smaller geographic area and may allow unrestricted access by UEs with service subscriptions with the network provider. A femto cell would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). An eNB for a macro cell may be referred to as a macro eNB. An eNB for a pico cell may be referred to as a pico eNB. And, an eNB for a femto cell may be referred to as a femto eNB or a home eNB. An eNB may support one or multiple (e.g., two, three, four, and the like) cells.

The wireless network 100 may support synchronous or asynchronous operation. For synchronous operation, the eNBs may have similar frame timing, and transmissions from different eNBs may be approximately aligned in time. For asynchronous operation, the eNBs may have different frame timing, and transmissions from different eNBs may not be aligned in time. The techniques described herein may be used for either synchronous or asynchronous operations.

The UEs 115 may be dispersed throughout the wireless network 100, and each UE may be stationary or mobile. A UE 115 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A UE 115 may be a cellular phone, a personal digital assistant (PDA), a wireless modem, a wireless communication device, a handheld device, a tablet computer, a laptop computer, a cordless phone, a wireless local loop (WLL) station, or the like. A UE may be able to communicate with macro eNBs, pico eNBs, femto eNBs, relays, and the like.

The communication links 125 shown in network 100 may include uplink (UL) transmissions from a mobile device 115 to a base station 105, and/or downlink (DL) transmissions, from a base station 105 to a mobile device 115. The downlink transmissions may also be called forward link transmissions while the uplink transmissions may also be called reverse link transmissions.

The core network 130 may communicate with the eNBs 105 via backhaul links 132 (e.g., S1, etc.). The eNBs 105 may also communicate with one another, e.g., directly or indirectly via backhaul links 134 (e.g., X2, etc.) and/or via backhaul link 132 (e.g., through core network 130). Backhaul links 134 between wireless links and backhaul link 132 to core network 130 may be wireless links implemented using transmitters and receivers at the base stations 105. In certain examples, one or more pairs of the eNBs 105 may be able to establish backhaul links 134 with each other over LOS frequencies. Other pairs of eNBs 105 may not be within a line of sight of each other, and may establish backhaul links 134 over NLOS frequencies. According to the principles of the present description, each of the eNBs 105 may utilize the same multi-mode modem for establishing backhaul links 134, regardless of whether the backhaul links 134 are over an LOS band or an NLOS band. The multi-mode modems may implement robust backhaul links 134 over a wide range of frequencies based on the use of frequency equalization and a CSC signal with a variable-length CP.

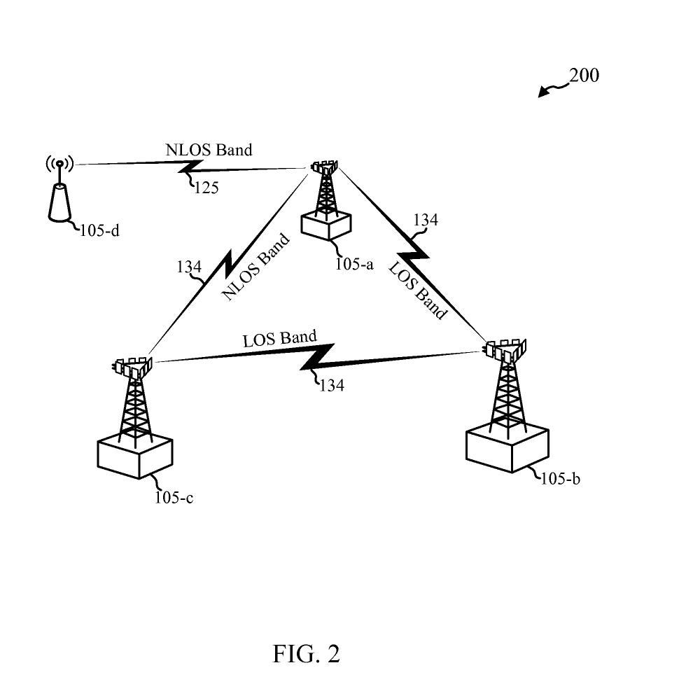

Turning to FIG. 2, there is shown a block diagram of a wireless communications system 200 including four base stations 105-a, 105-b, 105-c, and 105-d. The system 200 may be an example of the system 100 of FIG. 1.

In the present example, base stations 105-a and 105-b may communicate wirelessly over a backhaul link 134 operating in an LOS band, as do base stations 105-b and 105-c. Base stations 105-a and 105-c, however, may communicate over a backhaul link operating in an NLOS band, as may base station 105-a and femto cell 105-d (via communication link 125). Despite the different frequency bands in which the base stations 105 communicate, potentially ranging, for example, from less than 6 GHz to over 90 GHz, each of the base stations 105 may utilize the same multi-mode wireless modem, configured or programmed in accordance with the frequency band(s) in use by a particular one of the base stations 105. The use of the same multi-mode modem in each of the base stations 105 may provide streamlined manufacturing, distribution, management and support for base stations operating within a wide range of frequency bands. Use of the same modem hardware may be possible for various reasons, such as the use of cyclic single carriers (CSCs), the use of a cyclic prefix (CP) tuning module, frequency domain equalization, and time domain phase noise suppression, as described below.

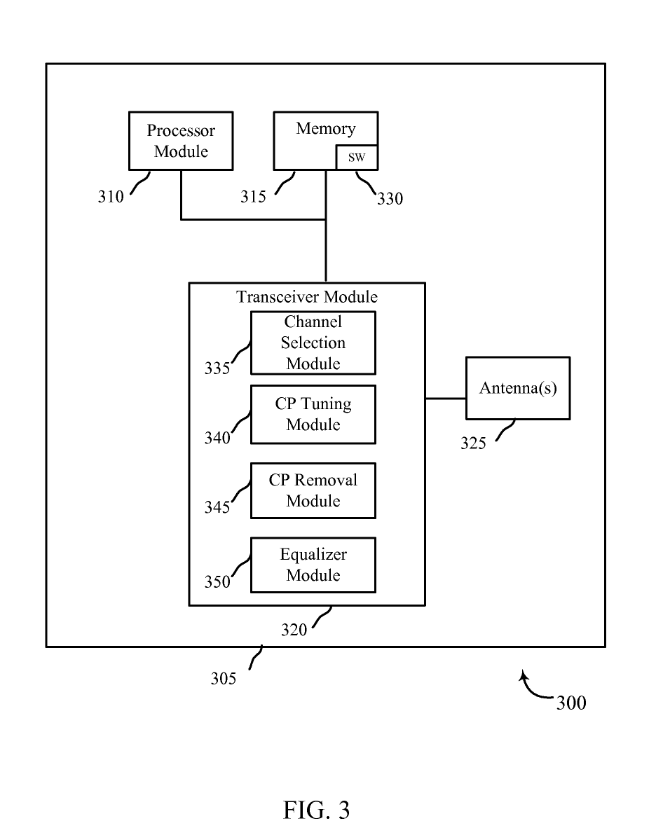

Referring now to FIG. 3, a block diagram 300 illustrates an apparatus or device 305 usable for wireless communication in accordance with various embodiments. The device 305 may in some cases be a multi-mode wireless modem used by one of the base stations 105 described with reference to FIG. 1 or FIG. 2. The device 305 may include a processor module 310, a memory 315, a transceiver module 320, and/or antenna(s) 325. Each of these components may be in communication, directly or indirectly, with each other (e.g., over one or more buses).

The components of the device 305 may, individually or collectively, be implemented with one or more application-specific integrated circuits (ASICs) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs), and other Semi-Custom ICs), which may be programmed in any manner known in the art. In some cases, some or all of the components of the device 305 may be integrated in a System on Chip (SOC) device. The functions of each unit may also be implemented, in whole or in part, with instructions embodied in a memory, formatted to be executed by one or more general or application-specific processors.

The processor module 310 may include an intelligent hardware device, e.g., a central processing unit (CPU), a microcontroller, an application-specific integrated circuit (ASIC), etc.

The memory 315 may include random access memory (RAM) or read-only memory (ROM). The memory 315 may also store computer-readable, computer-executable software code 330 containing instructions that are configured to, when executed, cause the processor module 310 to perform various functions described herein. Alternatively, the software code 330 may not be directly executable by the processor module 310 but be configured to cause the processor module 310, e.g., when compiled and executed, to perform functions described herein.

The transceiver module 320 may be configured to communicate bi-directionally, via the antenna(s) 325, with one or more other devices such as one or more multi-mode wireless modems of other base stations 105. The transceiver module 320 may be configured to modulate packets of data and provide the modulated packets to the antenna(s) 325 for transmission, and to demodulate packets received from the antenna(s) 325. While some examples of the device 305 may include a single antenna 325, in other examples, the device 305 may include multiple antennas 325 for multiple carriers.

In some embodiments, the transceiver module 320 in conjunction with antenna(s) 325, along with other possible components of the device 305, may facilitate wireless communication with one or more other devices (e.g., one or more multi-mode wireless modems of other base stations 105). To facilitate wireless communication, the transceiver module 320 may include a channel selection module 335, a cyclic prefix (CP) tuning module 340, a CP removal module 345, and/or an equalizer module 350.

The channel selection module 335 may select a single carrier wireless channel over which the device 305 may receive signals. The channel may be selected from among a number of channels over which the device 305 may receive signals, depending on a programmable configuration. For example, the device 305 may be capable of receiving signals over both an LOS band and an NLOS band, and may be configured to receive signals over a single carrier wireless channel selected from one of these bands. The LOS band may include carrier frequencies greater than 6 GigaHertz (GHz), such as microwave Point-to-Point (PtP) or E-Band small cell signals, while the NLOS band may include signals below 6 GHz.

The CP tuning module 340 may be configured to tune a CP length associated with a receiver of the transceiver module based on an estimated delay spread of the selected single carrier wireless channel. In some embodiments, the estimated delay spread may be a maximum estimated delay spread associated with the selected single carrier wireless channel. A channel in the LOS band (i.e., a higher frequency channel) may be associated with a shorter delay spread, and thus the CP length may be reduced to minimize overhead and increase system capacity, while still offering good robustness against phase noise and keeping the equalization method in the frequency domain simple. In some cases, the CP length may be reduced to a single symbol (e.g., in a millimeter-wave application). This may minimize overhead while ensuring single-carrier characteristics in terms of robustness against phase noise and low PAPR. A channel in the NLOS band (i.e., a lower frequency band) will typically be associated with a longer delay spread, and thus the CP length may be increased to match OFDM-like performance and reduce PAPR. In order to reduce CP overhead, the length of a frequency domain block (FDE-block) on which frequency domain equalization is performed may be extended.

The CP removal module 345 may be configured to identify and remove the CP associated with an FDE-block. An FDE-block may be a group of N modulated time-domain complex signals that are buffered to form a frequency domain equalization (FDE) block, with the last symbols (referred to as the CP of the block) being concatenated cyclically to its header.

The equalizer module 350 may be configured to perform frequency equalization (FDE) on a received FDE-block. As discussed above, the use of a CP frequency domain equalization may reduce ISI, thereby enabling single-tap frequency domain equalization, and avoiding the utilization of a time-domain equalization, which is inherently power consuming, more complex, and hard-limited in maximum delay spread supported. In certain examples, the equalizer module 350 may perform certain aspects of equalization in the frequency domain, and other aspects of the equalization in the time domain. For example, the equalizer module 350 may apply an equalizer filter (e.g., a single-tap equalizer filter) in the frequency domain to the FDE blocks of multiple spatially multiplexed signals, and then combine the equalized spatially multiplexed signals in the time domain to effectuate spatial equalization.

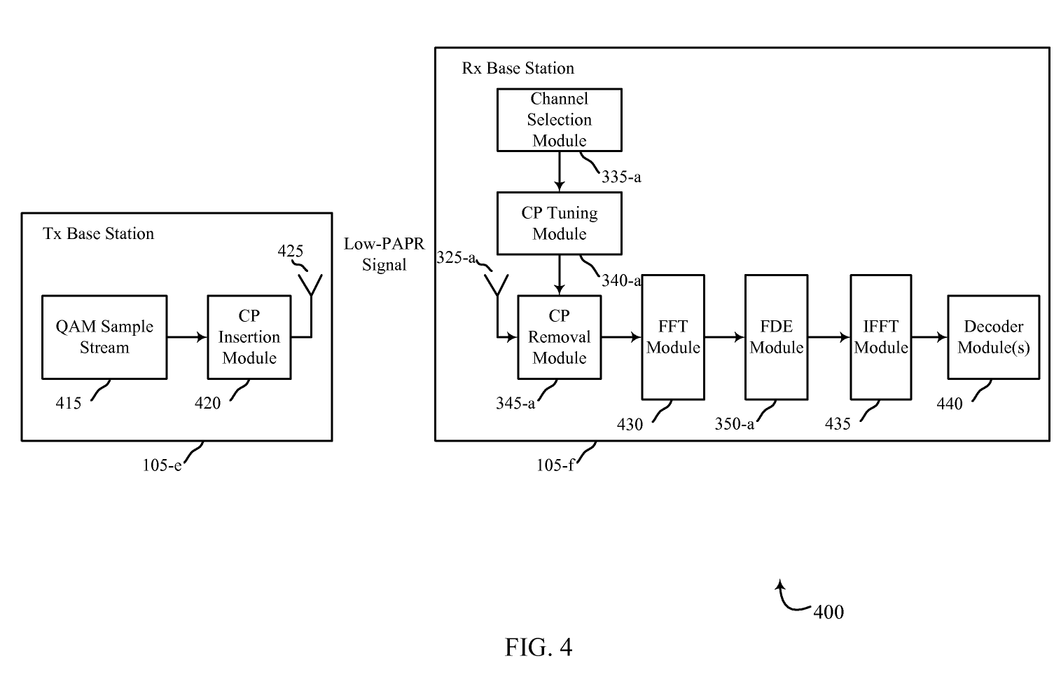

FIG. 4 is a block diagram 400 of example first and second base stations 105-e, 105-f capable of communicating via a CSC transmit/receive pipeline. The base stations 105 may in some cases be ones of the base stations 105 described with reference to FIG. 1 or FIG. 2. Although each of the base stations 105 may be capable of transmitting and receiving to/from the other, the first base station 105-e is shown for purposes of illustration to be a transmitting (Tx) base station, while the second base station 105-f is shown to be a receiving (Rx) base station. In some embodiments, the receiving base station 105-f may include components of the device 305 described with reference to FIG. 3.

The transmitting base station 105-e may include a CP insertion module 420 and antenna(s) 425. The CP insertion module 420 may receive a Quadrature Amplitude Modulated (QAM) sample stream 415 generated by the transmitting base station 105-e and insert a CP for each FDE-block of the QAM sample stream 415. The length of the CP may be based at least in part on an estimated delay spread of the single carrier wireless channel selected for transmission. The QAM sample stream 415 with inserted CPs may then be transmitted to the receiving base station 105-f via antenna(s) 425.

The receiving base station 105-f may include antenna(s) 325-a, a channel selection module 335-a, a CP tuning module 340-a, a CP removal module 345-a, a Fast Fourier Transform (FFT) module 430, an FDE module 350-a, an inverse FFT (IFFT) module 435, and decoder module(s) 440. The channel selection module 335-a, CP tuning module 340-a, CP removal module 345-a, and/or FDE module 350-a may in some cases be configured similarly to respective ones of the channel selection module 335, CP tuning module 340, CP removal module 345, and/or FDE module 350 described with reference to FIG. 3.

The FFT module 430 may be positioned after the CP removal module 345-a, but prior to the FDE module 350-a, in the receive pipeline of the base station 105-f. The IFFT module 435 may be positioned after the FDE module 350-a in the receive pipeline. In comparison to an OFDM transmit/receive pipeline, the IFFT module may be located in a different position in the CSC transmit/receive pipeline. By contrast, in an OFDM environment, the IFFT 435 module may be is positioned in the transmit chain of a base station, prior to a CP insertion module (e.g., prior to the CP insertion module 420 of the transmitting base station 105-e). By moving the IFFT module to the receive pipeline, and downstream from the FDE module 350-a, the signal sent between a transmitting base station 105-e and a receiving base station becomes a low-PAPR signal instead of a high-PAPR signal, and it becomes easier to mitigate phase noise in the time domain. The robustness in multipath channels and low level of receiver complexity may, however, remain the same as in an OFDM environment.

The decoder module(s) 440 may further process a received signal in the time domain to decode the modulated bits from the received signal, following frequency domain equalization in the frequency domain.

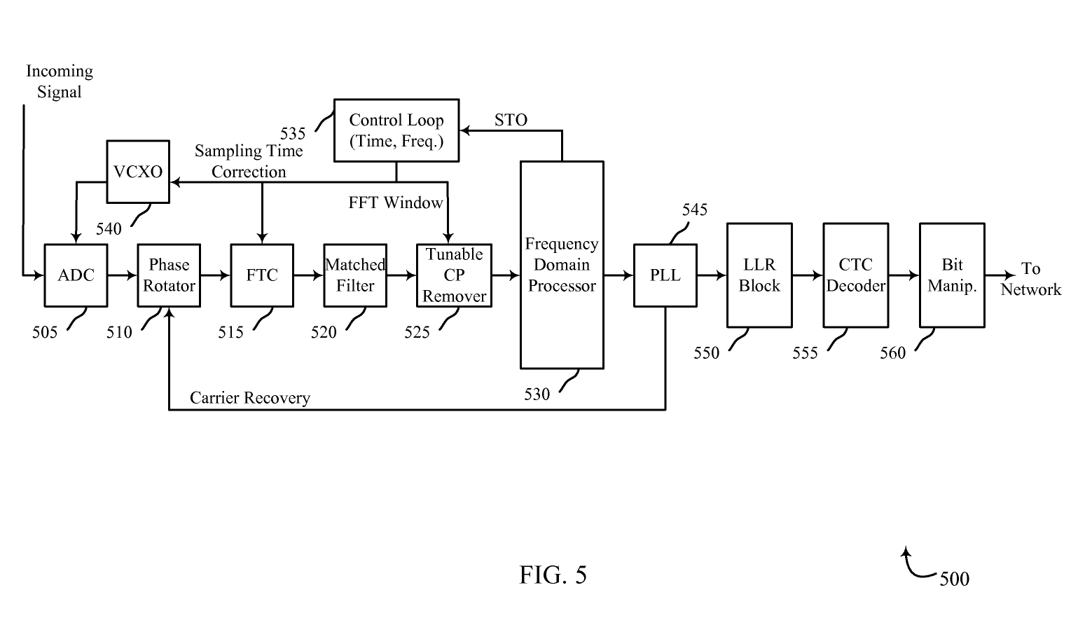

FIG. 5 is a block diagram 500 of a Single-In-Single-Out receive pipeline in the physical (PHY) layer. The receive pipeline may in some cases be incorporated into one of the base stations 105 described with reference to FIG. 1, FIG. 2, or FIG. 4, or into the device 305 described with reference to FIG. 3. The receive pipeline may include an analog-to-digital converter (ADC) 505, a phase rotator circuitry 510, a fine timing correction (FTC) circuitry 515, a matched filter 520, a tunable CP remover 525, a frequency domain processor 530, a control loop 535, a voltage-controlled crystal oscillator (VXCO) 540, a phase locked loop (PLL) 545, a log likelihood ratio (LLR) block 550, a convolutional turbo code (CTC) decoder 555, and a bit manipulator 560.

An incoming signal on a selected CSC wireless channel may be sampled by the external ADC 505 and converted to digital form. In some embodiments, the incoming signal may include groups of N modulated time-domain complex signals that are buffered to form a frequency domain equalization (FDE) block, with the last symbols (referred to as the CP of the block) being concatenated cyclically to its header. The digital signal may then be processed through various blocks before having a CP removed from each FDE-block of the signal at the tunable CP remover 525. Assuming the channel delay spread is smaller than the CP length, removal of the CP may yield ISI-free symbols.

After CP removal, an FDE-block of symbols may be processed by the frequency domain processor 530. The processor 530 may process symbols on a block-by-block basis. At the frequency domain processor 530, the symbols may go through an FFT engine performing an FFT of flexible size N_{FFT} prior to frequency domain equalization. Prior to time domain processing (e.g., phase recovery at PLL block 545, LLR computation at the LLR block 550, CTC decoding at the CTC decoder block 555, and bit manipulation at the bit manipulation block 560), the symbols may go through an IFFT engine performing an IFFT of length N_{FFT}.

The frequency domain processor 530 may perform channel estimation and equalization. Channel estimation may be performed using the preamble of the FDE-block, with the result of the channel estimation being used for the entire FDE-block. Frequency domain equalization on the data portion of the FDE-block may be accomplished using an interpolated channel estimation (from channel estimation resolution to data symbol resolution). After equalization, the IFFT of length N_{FFT} may be performed to produce equalized time domain samples. The processor 530 may also determine a Sample Time Offset (STO) and Carrier to Interference-plus-Noise Ratio (CINR). Both of these estimations may be derived from the preamble of the FDE-block. More details regarding the frequency domain processing performed by the processor 530 are provided later in this description.

The time domain based control loop 535 may be used to acquire a source sampling clock frequency, filtering the clock source phase noise to provide a clean and accurate sampling clock to the external ADC 505. The control loop 535 may be responsive to the STO for a single preamble, and may be operative to adjust a sample time associated with the incoming signal in the time domain, based at least in part on the STO. This may be done by generating and outputting a sampling time correction to the VCXO 540. The VCXO 540, in turn, may generate the clocks for the ADC 505 and receive pipeline (including the FTC 515 and tunable CP remover 525). In this manner, a closed timing loop may be implemented. The control loop 535 may also select the FFT window size (N_{FFT}) associated with frequency domain processing of the incoming signal, again based at least in part on the STO.

Phase noise suppression may be provided by detecting a phase error in the frequency equalized incoming signal output from the frequency domain processor 530, and then rotating the phase of the incoming signal, pre-frequency domain processing, to correct the phase error. This may be accomplished using a phase noise suppression module such as the PLL 545 and the phase rotator circuitry 510.

The PLL 545 may be configured to detect the phase error in the frequency equalized incoming signal output by the frequency domain processor. Although phase noise may not typically an issue for signals in the NLOS band (below 6 GHz), it can become an issue for signals in the LOS band (above 6 GHz).

The PLL 545 may operate in different modes, such as SISO mode, Dual SISO mode, or cross-polarization interference cancellation (XPIC) mode. Each of these modes may be suitable for a different topology of receiver. A SISO mode receiver is shown in FIG. 5. A Dual SISO mode receiver may be implemented by replicating the illustrated receive pipeline for each antenna of a Dual SISO mode receiver.

In SISO mode, the PLL 545 may operate as a digital PLL (DPLL) for tracking the phase noise introduced by radio frequency (RF) synthesizers. The PLL 545 may also estimate the long term frequency error and track its offset due to slow variations with temperature change. Typically, it cannot be assumed that phase noise remains constant over an FDE-block. Phase noise therefore may be detected on a sample-by-sample basis.

The DPLL may begin its phase error detection in an acquisition mode, typically based on a pilot sequence of an FDE-block preamble, pilots embedded in the data blocks (which may lower the code rate or throughput), or another known sequence. The DPLL may then switch to a tracking mode when it obtains a phase error “lock” (e.g., when the phase error is below a defined threshold). Typically, the DPLL may perform its operations at the symbol rate. However, operation at a lower rate may be possible. In some cases, the DPLL may utilize a second order loop to enable frequency tracking with no tracking error.

When operating as a DPLL, the PLL 545 may evaluate detected phase error of the corrected signal received at its input and calculate a phase/rotation for correction of samples output from the ADC 505. The correction (“Carrier Recovery” signal in the figures) may then applied to the samples output from the ADC 505 using the phase rotator circuitry 510 disposed before the frequency domain processor 530 in the receive pipeline. Because the signal received by the PLL 545 may not be continuous in time (due to removal of the CP for each FDE-block), an educated phase jump may be made. For example, when a new block of contiguous symbols begins, the initial phase for the block may be calculated according to the length of the gap left by CP removal and the last known frequency state of the PLL 545.

In addition to PLL 545, an LLR block 550, CTC decoder 555, and bit manipulator 560 may provide further signal processing in the time domain, prior to outputting a received signal (e.g., to a core network connected to base station in which the receive pipeline shown in FIG. 5 is implemented. The LLR block 550 may calculate for every QAM symbol the soft bits which are input to the CTC decoder 555. The LLR block 550 may represent the 0/1 probability of every modulated bit according to the Max-Log-Map algorithm. The CTC decoder 555 validates the correctness of a decoded block using its CRC field.

In some embodiments, the frequency domain processor 530 may be implemented using a digital signal processor (DSP), whereas the transitions between time and frequency domains may be performed using hardware (HW) co-processors, thereby unloading some of the processing complexity from the DSP to the HW.

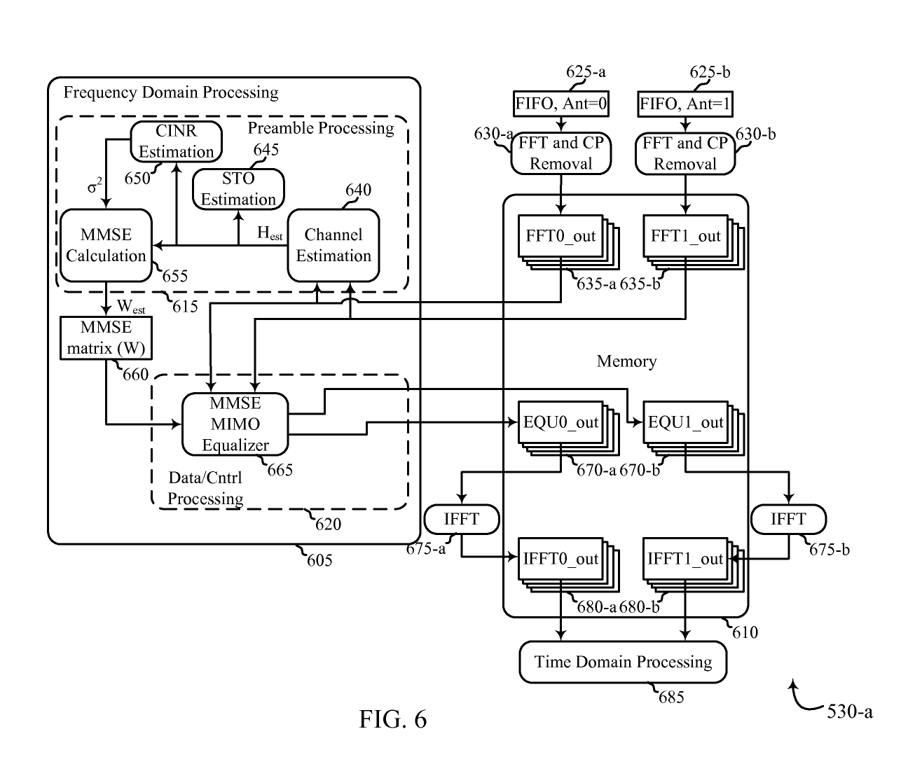

FIG. 6 illustrates a more detailed example of how the frequency domain processor 530 shown in FIG. 5 may be embodied when the SISO receive pipeline is replicated to form a Dual SISO receive pipeline having two antennas (Ant=0, Ant=1). The frequency domain processor 530-a may include a processing module 605 and a memory 610. The processing module 605 may include a preamble processing module 615 and a data and control (data/cntrl) processing module 620.

In the embodiment shown in FIG. 6, frequency domain equalization coefficients may be determined from the preamble (or other known sequence) of an FDE block transmitted ahead of the data in the FDE block. The preamble can also be utilized to derive many of the critical parameters necessary for practical implementation of communication systems, such as timing offset error due to clock jitter, or carrier frequency offset. Furthermore, such a preamble-based CSC implementation can easily derive channel and system statistics, such as Signal to Noise Ratio, interferences between polarizations in an XPIC system, RSSI (Received Signal Strength Indication), and so on.

An FDE-block may be initially received at first-in first-out (FIFO) modules 625-a, 625-b via respective antennas Ant=0 and Ant=1. An FFT and CP removal may then be performed for each channel at modules 630-a, 630-b and the frequency domain symbols output therefrom may be stored in FFT0_out and FFT1_out buffers 635-a, 635-b of the memory 610.

At the preamble processing module 615, the channel estimation module 640 may read the preamble symbols of the FDE-block from the FFT0_out and FFT1_out buffers 635-a, 635_{—}b and generate a channel estimation, Hₑₛₜ. The sample time offset (STO) estimation module 645 may estimate the STO of an FDE-block based on its preamble symbols, using a least squares algorithm. The CINR estimation module 650 may estimate the CINR, σ², of an FDE-block based on its preamble symbols.

By way of example, the processing module 605 of FIG. 6 is minimum mean squared error (MMSE)-based. In other embodiments, the processing module 605 may use other equalization techniques. The MMSE calculation module 655 performs a mean square error estimation based on the channel estimation, Hₑₛₜ, and the CINR estimation, σ². The channel used for MMSE calculation may be averaged between consecutive preambles to reduce the noise floor. The result of the MMSE calculation may be an MMSE matrix (W) 660 specifying frequency domain equalization coefficients. These coefficients may be used by the MMSE MIMO equalizer 665 of the data and control processing module 620 to perform frequency domain equalization on the data symbols of an FDE-block retrieved from the FFT0_out and FFT1_out buffers 635-a, 635-b. Frequency domain equalization may then be performed using an interpolated channel estimation. The outputs of the MMSE MIMO equalizer 665 may be stored in EQU0_out and EQU1_out buffers 670-a, 670-b.

IFFT modules 675-a, 675-b may be used to perform an IFFT on the data stored in the EQU0_out and EQU1_out buffers 670-a, 670-b. The outputs of the IFFT modules 675-a, 675-b may be stored in the IFFT0_out and IFFT1_out buffers 680-a, 680-b and are retrievable for subsequent time domain processing 685.

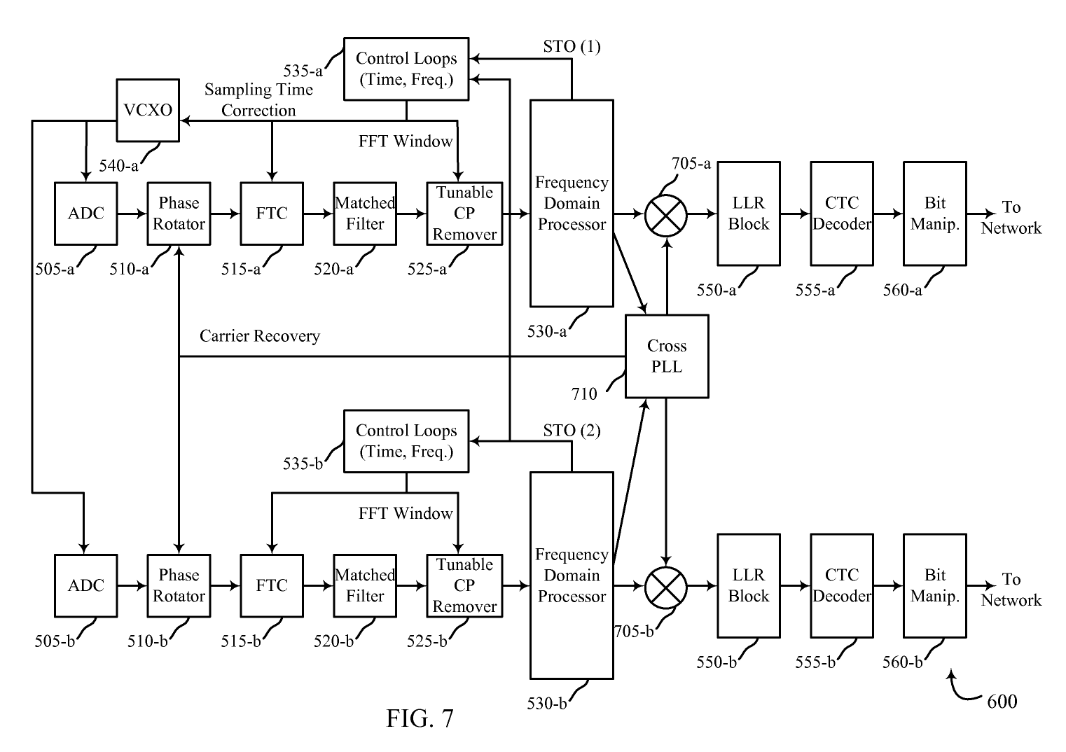

FIG. 7 is a block diagram 700 of an XPIC receive pipeline in the PHY layer. The receive pipeline may in some cases be incorporated into one of the base stations 105 described with reference to FIG. 1 or FIG. 2, or into the device 305 described with reference to FIG. 3. The receive pipeline may include, for each antenna, an ADC 505-a, 505-b, a phase rotator 510-a, 510-b, an FTC 515-a, 515-b, a matched filter 520-a, 520-b, a tunable CP remover 525-a, 525-b, a frequency domain processor 530-a, 530-b, a control loop 535-a, 535-b, a PLL 545-a, a combiner 705-a, 705-b, a log likelihood ratio (LLR) block 550-a, 550-b, a CTC decoder 555-a, 555-b, and a bit manipulator 560-a, 560-b. The receive pipeline may also include a shared VXCO 540-a and a cross PLL 710. The descriptions of components having corresponding components described with reference to FIG. 5 will not be repeated.

The cross PLL 710 may receive input from the frequency domain processors 530-a, 530-b in both XPIC channels and provide outputs to the phase rotators 510-a, 510-b and the combiners 705-a, 705-b. The cross PLL 710 for an XPIC receive pipeline may utilize four independent running instances of a DPLL kernel for each data path. However, the number of DPLLs can be reduced if the same RF local oscillators (see, e.g., VCXO 540-a) are used for the transmit and receive RF carriers in both XPIC chains. In this case, and for the second XPIC channel only (the channel beginning with ADC 505-b), rotation on samples output from the ADC 505-b can be performed with correction determined in the DPLL for the first XPIC channel (beginning with ADC 505-a).

Each combiner 705-a, 705-b may receive inputs from a respective one of the frequency domain processors 530-a, 530-b and the cross PLL 710, and provide a signal output to a respective downstream LLR block 550-a, 550-b.

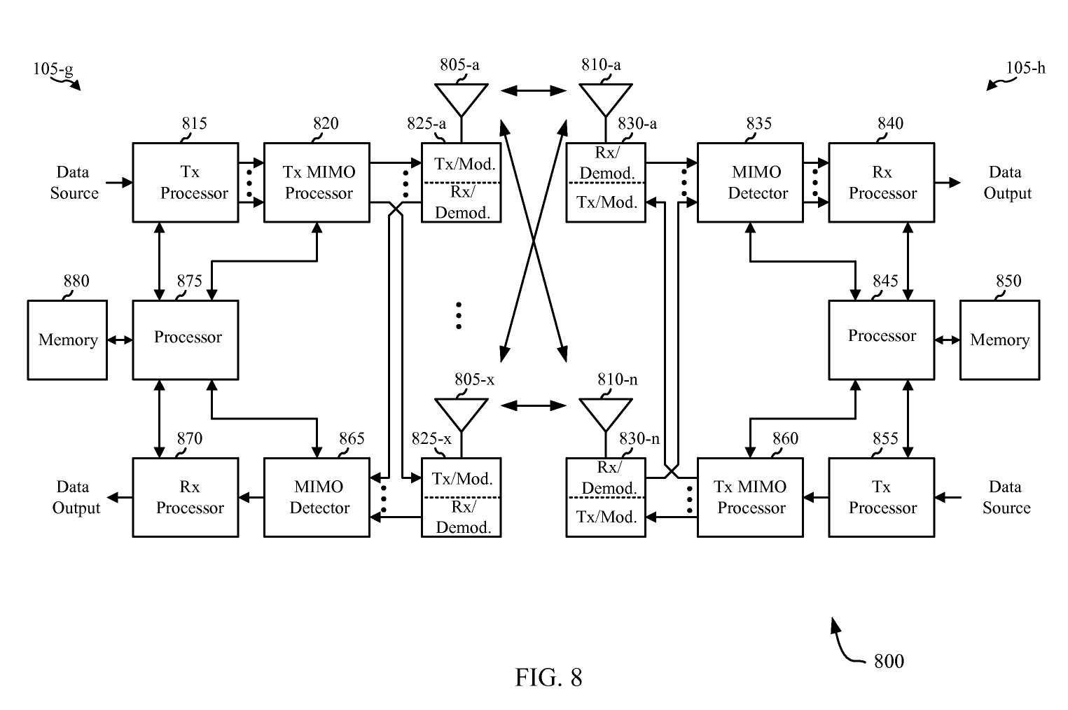

FIG. 8 is a block diagram of a MIMO communications system 800 including a base station 105-g and a base station 105-h. The system 800 may illustrate aspects of the system 100 of FIG. 1 and/or system 200 of FIG. 2. The base station 105-g may be equipped with antennas 805-a through 805-x, and the base station 105-h may be equipped with antennas 810-a through 810-n. In the system 800, each of the base stations 105-g, 105-h may be able to send data over multiple communication links at the same time. Each communication link may be called a “layer” and the “rank” of the communication link may indicate the number of layers used for communication. For example, in a 2×2 MIMO system where base station 105-g transmits two “layers,” the rank of the communication link between the base station 105-g and the base station 105-h is two.

At the base station 105-g, a transmit processor 815 may receive data from a data source. The transmit processor 815 may process the data. The transmit processor 815 may also generate reference symbols, and a cell-specific reference signal. A transmit (TX) MIMO processor 820 may perform spatial processing (e.g., precoding) on data symbols, control symbols, and/or reference symbols, if applicable, and may provide output symbol streams to the transmit modulators 825-a through 825-x. Each modulator 825 may process a respective output symbol stream (e.g., for CSC, etc.) to obtain an output sample stream. Each modulator 825 may further process (e.g., convert to analog, amplify, filter, and upconvert) the output sample stream. In one example, signals from modulators 825-a through 825-x may be transmitted via the antennas 805-a through 805-x, respectively.

At the base station 105-h, the antennas 810-a through 810-n may receive the signals transmitted from the base station 105-d and may provide the received signals to the demodulators 830-a through 830-n, respectively. Each demodulator 830 may condition (e.g., filter, amplify, downconvert, and digitize) a respective received signal to obtain input samples. Each demodulator 830 may further process the input samples (e.g., for OFDM, etc.) to obtain received symbols. A MIMO detector 835 may obtain received symbols from all the demodulators 830-a through 830-n, perform MIMO detection on the received symbols if applicable, and provide detected symbols. A receive processor 840 may process (e.g., demodulate, deinterleave, and decode) the detected symbols, providing decoded data for the base station 105-h to a data output, and provide decoded control information to a processor 845, or memory 850.

At the base station 105-h, a transmit processor 855 may receive and process data from a data source. The transmit processor 855 may also generate reference symbols for a reference signal. The symbols from the transmit processor 855 may be precoded by a transmit MIMO processor 860 if applicable, further processed by the demodulators 830-a through 830-n (e.g., for SC-FDMA, etc.), and be transmitted to the base station 105-g in accordance with the transmission parameters received from the base station 105-g. At the base station 105-g, the signals transmitted from the base station 105-h may be received by the antennas 805, processed by the demodulators 825, detected by a MIMO detector 865 if applicable, and further processed by a receive processor 870. The receive processor 870 may provide decoded data to a data output and to the processor 875 or memory 880.

In some embodiments, some or all of the receive pipeline components described with reference to FIGS. 3, 4, 5, 6, and/or 7 may be implemented within one or more of the receive (Rx) demodulators 825 or 830 of the base station 105-g or the base station 105-h.

The components of the base station 105-g may, individually or collectively, be implemented with one or more Application Specific Integrated Circuits (ASICs) adapted to perform some or all of the applicable functions in hardware. Each of the noted modules may be a means for performing one or more functions related to operation of the system 800. Similarly, the components of the base station 105-h may, individually or collectively, be implemented with one or more Application Specific Integrated Circuits (ASICs) adapted to perform some or all of the applicable functions in hardware. Each of the noted components may be a means for performing one or more functions related to operation of the system 800.

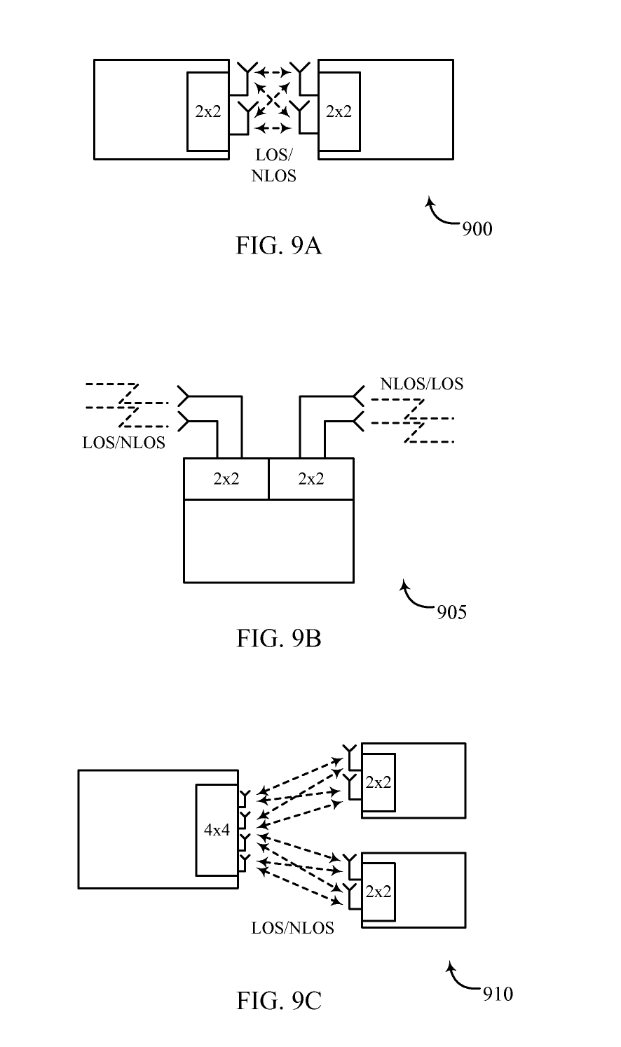

FIGS. 9A, 9B and 9C depict various implementations of advanced link topologies 900, 905, 910 that are capable of being supported with a single configurable or programmable CSC based system (e.g., device 305 shown in FIG. 3, base station 410 shown in FIG. 4, base station 105-e or 105-f shown in FIG. 8, or any of the receive pipelines shown in FIGS. 5-7). By way of example, the first topology 900 is a point-to-point link, the second topology 905 is a dual-mode relay, and the third topology 910 is a point-to-multipoint link. Each of the topologies 900, 905, 910 may be implemented across a different frequency band, but using the same underlying CSC based system. In such embodiments, for example, the system may implement a dual-mode relay 905 capable of distributing a high capacity E-band (60-90 GHz) link to an NLOS-backhauled base station, yet also implement a microwave relay for extended range, merely by tuning the CP length according to a desired operating frequency band.

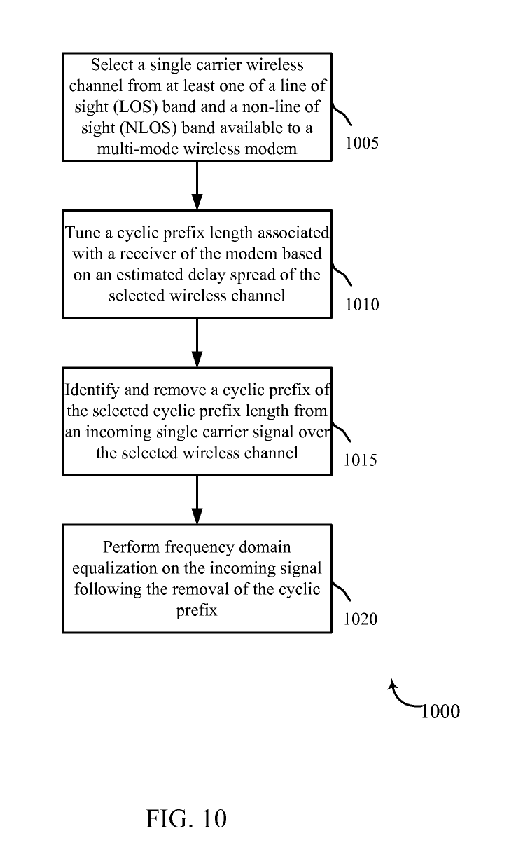

FIG. 10 is a flow chart illustrating one example of a method 1000 of wireless communication at a multi-mode wireless modem. For clarity, the method 1000 is described below with reference to the device 305 shown in FIG. 3, or one of the receive pipelines shown in FIGS. 5-7, or one of the base stations 105 shown in FIGS. 1, 2, 4, and/or 8. In one implementation, the channel selection module 335, CP tuning module 340, CP removal module 345, and FDE module 350 shown in FIG. 3 may execute one or more sets of codes to control the functional elements of the devices 305 to perform the functions described below.

At block 1005, the method 1000 may select a single carrier wireless channel from at least one of an LOS band a NLOS band available to a multi-mode wireless modem (e.g., the device 305 shown in FIG. 3). At block 1010, a CP length associated with a receiver of the modem may be tuned based on an estimated delay spread of the selected wireless channel. At block 1015, a CP of the selected CP length may be identified and removed from an incoming single carrier signal over the selected wireless channel. At block 1020, frequency domain equalization may be performed on the incoming signal following removal of the CP.

Thus, the method 1000 may provide wireless communications over most any frequency band, from the NLOS band to the LOS band. It should be noted that the method 1000 is just one implementation and that the operations of the method 1000 may be rearranged or otherwise modified such that other implementations are possible.

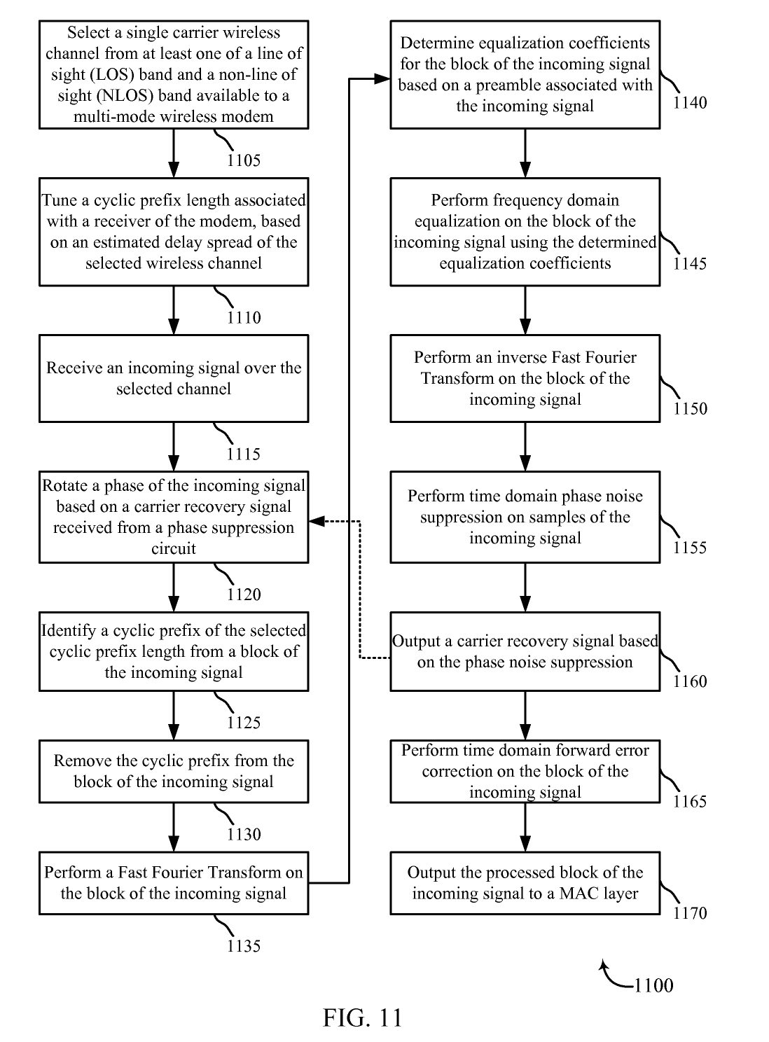

FIG. 11 is a flow chart illustrating one example 1100 of a more detailed implementation of the method 1000 shown in FIG. 10. For clarity, the method 1100 is described below with reference to the device 305 shown in FIG. 3, or one of the receive pipelines shown in FIGS. 5-7, or one of the base stations 105 shown in FIGS. 1, 2, 4, and/or 8.

At block 1105, the method 1100 selects a single carrier wireless channel from at least one of an LOS band a NLOS band available to a multi-mode wireless modem. In some embodiments, the modem may be the device 305 shown in FIG. 3, and the selection may be made using the channel selection module 335 shown in FIG. 3 or FIG. 4. At block 1110, a CP length associated with a receiver of the modem may be tuned based on an estimated delay spread of the selected wireless channel. In some embodiments, the tuning may be accomplished using the CP tuning module 340 shown in FIG. 3 or FIG. 4.

At block 1115, an incoming signal is received over the channel selected in block 1105. The incoming signal may be received, in some cases, by any of the receive pipelines shown in FIG. 3-5, 7 or 8.

At block 1120, a phase of the incoming signal may be rotated based on a carrier recovery signal received from a phase suppression circuit. In some embodiments, the phase suppression circuit may be the PLL 545 shown in FIG. 5 or the cross PLL 710 shown in FIG. 7.

At block 1125, a CP of the selected CP length may be identified in a block of the incoming signal, and at block 1130, the CP is removed from the block of the incoming signal. These actions may be performed, in some embodiments, using the CP removal module 345 shown in FIG. 3 or FIG. 4, or the tunable CP remover 525 shown in FIG. 5 or FIG. 7, or the FFT and CP removal modules 630-a, 630-b shown in FIG. 6.

At block 1135, a Fast Fourier Transform may be performed on the block of the incoming signal. This may be done, in some embodiments, by the FFT module 430 shown in FIG. 4, or the frequency domain processor 530 shown in FIG. 5 or FIG. 7, or the FFT and CP removal modules 630-a, 630-b shown in FIG. 6.

At block 1140, equalization coefficients may be determined for the block of the incoming signal. The equalization coefficients may be determined based on a preamble associated with the incoming signal, and in some cases a pilot of the preamble. The equalization coefficients may in some cases be MMSE coefficients. In some embodiments, the equalization coefficients may be determined by the FDE module 350 shown in FIG. 3 or FIG. 4, or the frequency domain processor 530 shown in FIG. 5 or FIG. 7, or the MMSE calculation module 655 shown in FIG. 6.

At block 1145, frequency domain equalization may be performed on the block of the incoming signal using the determined equalization coefficients. The frequency domain equalization may be performed by the FD equalizer module 350 shown in FIG. 3 or FIG. 4, or the frequency domain processor 530 shown in FIG. 5 or FIG. 7, or the MMSE MIMO equalizer 665 shown in FIG. 6. In some cases, the frequency domain equalization may be performed using a single-tap frequency domain equalization circuit.

An inverse Fast Fourier Transform is performed on the block of the incoming signal at block 1150. In some embodiments, the inverse Fast Fourier Transform may be performed by the IFFT module 435 shown in FIG. 4, or the frequency domain processor 530 shown in FIG. 5 or FIG. 7, or the IFFT modules 665-a, 665-b shown in FIG. 6.

Having returned the processing flow to the time domain, at block 1155, time domain phase noise suppression may be performed on samples of the incoming signal. The phase noise suppression may in some cases be performed by the PLL 545 shown in FIG. 5 or the cross PLL 710 shown in FIG. 7. At block 1160, a carrier recovery signal based on the phase noise suppression may be output. Examples of carrier recovery signals are shown in FIG. 5 and FIG. 7. As shown in FIG. 11, the carrier recovery signal may be used to rotate the phase of the incoming signal at block 1120.

At block 1165, time domain forward error correction may be performed on the block of the incoming signal. This may be accomplished, in some embodiments, using the CTC decoder 555 shown in FIG. 5 or FIG. 7. The processed block of the incoming signal may thereafter be output to a medium access control (MAC) layer, possibly after further processing.

Thus, the method 1100 may provide wireless communications over most any frequency band, from the NLOS band to the LOS band. It should be noted that the method 1100 is just one implementation and that the operations of the method 1100 may be rearranged or otherwise modified such that other implementations are possible.

The detailed description set forth above in connection with the appended drawings describes exemplary embodiments and does not represent the only embodiments that may be implemented or that are within the scope of the claims. The term “exemplary” used throughout this description means “serving as an example, instance, or illustration,” and not “preferred” or “advantageous over other embodiments.” The detailed description includes specific details for the purpose of providing an understanding of the described techniques. These techniques, however, may be practiced without these specific details. In some instances, well-known structures and devices are shown in block diagram form in order to avoid obscuring the concepts of the described embodiments.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with at least one processor, such as a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

A computer program product or computer-readable media includes both computer-readable storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired computer-readable program code in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the spirit or scope of the disclosure. Throughout this disclosure the term “example” or “exemplary” indicates an example or instance and does not imply or require any preference for the noted example. Thus, the disclosure is not to be limited to the examples and designs described herein but is to be accorded the widest scope consistent with the principles and novel features disclosed herein.

What is claimed is:

1. A method of wireless communication at a multi-mode wireless modem, comprising:
selecting a wireless channel from one of a line of sight (LOS) band or a non-line of sight (NLOS) band for receiving an incoming cyclically prefixed single carrier signal, wherein the modem is capable of receiving signals over both the LOS band and the NLOS band;
tuning a cyclic prefix length associated with the incoming single carrier signal based on an estimated delay spread of the selected wireless channel;
identifying and removing a cyclic prefix of the cyclic prefix length from the incoming single carrier signal over the selected wireless channel; and
performing frequency domain equalization on the incoming single carrier signal following the removal of the cyclic prefix.

2. The method of claim 1, further comprising:
performing phase noise suppression on the incoming single carrier signal in a time domain following the frequency domain equalization.

3. The method of claim 2, wherein performing the phase noise suppression comprises:
detecting a phase error in the frequency equalized incoming single carrier signal using a time domain phase locked loop.

4. The method of claim 3, further comprising:
using the detected phase error to rotate a carrier frequency offset originated phase of the incoming single carrier signal before performing the frequency domain equalization in a receive pipeline.

5. The method of claim 2, further comprising:
performing the frequency domain equalization on a block-by-block basis;
transforming the equalized blocks to the time domain; and
suppressing the phase noise in the incoming single carrier signal on a sample-by-sample basis.

6. The method of claim 1, further comprising:
determining frequency domain equalization coefficients for the incoming single carrier signal based at least in part on a pilot sequence of a preamble of the incoming single carrier signal.

7. The method of claim 1, further comprising:
determining a sample time offset associated with the incoming single carrier signal in the frequency domain; and
adjusting a sample time associated with the incoming single carrier signal in the time domain based at least in part on the sample time offset.

8. The method of claim 7, further comprising:
selecting a Fast Fourier Transform window size associated with frequency domain processing of the incoming single carrier signal based at least in part on the sample time offset.

9. The method of claim 1, wherein the frequency domain equalization is performed by a single-tap frequency domain equalization circuit.

10. The method of claim 1, wherein the estimated delay spread comprises a maximum estimated delay spread associated with the selected wireless channel.

11. The method of claim 1, wherein the NLOS band comprises microwave carrier frequencies below 6 GHz.

12. The method of claim 1, wherein the LOS band comprises carrier frequencies greater than 6 GHz.

13. A multi-mode wireless modem, comprising:
a channel selection module configured to select a wireless channel from one of a line of sight (LOS) band or a non-line of sight (NLOS) band for receiving an incoming cyclically prefixed single carrier signal, wherein the modem is capable of receiving signals over both the LOS band and the NLOS band;
a cyclic prefix tuning module configured to tune a cyclic prefix length associated with the incoming single carrier signal based on an estimated delay spread of the selected wireless channel;
a cyclic prefix removal module configured to identify and remove a cyclic prefix of the cyclic prefix length from the incoming single carrier signal received over the selected channel; and
a frequency domain equalization module configured to perform frequency domain equalization on the incoming single carrier signal following the removal of the cyclic prefix.

14. The multi-mode wireless modem of claim 13, further comprising:
a phase noise suppression module configured to perform phase noise suppression on the incoming single carrier signal in a time domain following the frequency domain equalization.

15. The multi-mode wireless modem of claim 14, wherein the phase noise suppression module further comprises:
a time domain phase locked loop, wherein the phase noise suppression module is configured to detect a phase error in the incoming single carrier signal following the frequency domain equalization and a transformation to the time domain using the time domain phase locked loop.

16. The multi-mode wireless modem of claim 15, further comprising:
phase rotator circuitry configured to receive at least a portion of the detected phase error and disposed before the frequency domain equalization module in a receive pipeline.

17. The multi-mode wireless modem of claim 14, further comprising:
inverse Fast Fourier Transform (IFFT) circuitry disposed between the frequency domain equalization module and the phase noise suppression module, the IFFT circuitry configured to transform the frequency equalized incoming single carrier signal into the time domain;
wherein the frequency domain equalization module is further configured to perform the frequency domain equalization on a block-by-block basis; and
wherein the phase noise suppression module is further configured to suppress the phase noise in a time domain version of the frequency equalized incoming single carrier signal on a sample-by-sample basis.

18. The multi-mode wireless modem of claim 13, wherein:
the frequency domain equalization module is further configured to determine frequency domain equalization coefficients for the incoming single carrier signal based at least in part on a pilot sequence of a preamble of the incoming single carrier signal.

19. The multi-mode wireless modem of claim 13, wherein the frequency domain equalization module comprises:
a single-tap frequency domain equalization circuit configured to perform the frequency domain equalization.

20. The multi-mode wireless modem of claim 13, wherein the estimated delay spread comprises a maximum estimated delay spread associated with the selected wireless channel.

21. The multi-mode wireless modem of claim 1, wherein the NLOS band comprises microwave carrier frequencies below 6 GHz.

22. The multi-mode wireless modem of claim 1, wherein the LOS band comprises carrier frequencies greater than 6 GHz.

23. An apparatus for receiving multi-mode wireless signals, the apparatus comprising:
means for selecting a wireless channel from one of a line of sight (LOS) band or a non-line of sight (NLOS) band for receiving an incoming cyclically prefixed single carrier signal, wherein the modem is capable of receiving signals over both the LOS band and the NLOS band;
means for tuning a cyclic prefix length associated with the incoming single carrier signal based on an estimated delay spread of the selected single carrier wireless channel;
means for identifying and removing a cyclic prefix of the cyclic prefix length from the incoming single carrier signal; and
means for performing frequency domain equalization on the incoming single carrier signal following the removal of the cyclic prefix.

24. The apparatus of claim 23, further comprising:
means for performing phase noise suppression on the incoming single carrier signal in a time domain following the means for performing frequency domain equalization in a receive pipeline.

25. The apparatus of claim 24, wherein the means for performing phase noise suppression comprises:
means for detecting a phase error in the frequency equalized incoming single carrier signal using a time domain phase locked loop.

26. The apparatus of claim 25, further comprising:
means for outputting the detected phase error to phase rotator circuitry disposed before the means for performing frequency domain equalization in the receive pipeline.

27. The apparatus of claim 24, further comprising:
means for performing the frequency domain equalization on a block-by-block basis; and
means for suppressing the phase noise in the incoming single carrier signal on a sample-by-sample basis.

28. The apparatus of claim 23, further comprising:
means for determining frequency domain equalization coefficients for the incoming single carrier signal based at least in part on a pilot sequence of a preamble of the incoming single carrier signal.

29. The apparatus of claim 23, further comprising:
means for determining a sample time offset associated with the incoming single carrier signal in the frequency domain; and
means for adjusting a sample time associated with the incoming single carrier signal in the time domain based at least in part on the sample time offset.

30. The apparatus of claim 29, further comprising:
means for selecting a Fast Fourier Transform window size associated with frequency domain processing of the incoming single carrier signal based at least in part on the sample time offset.

31. The apparatus of claim 23, wherein the frequency domain equalization is performed by a single-tap frequency domain equalization circuit.

32. The apparatus of claim 23, wherein the estimated delay spread comprises a maximum estimated delay spread associated with the selected wireless channel.

33. The apparatus of claim 23, wherein the NLOS band comprises microwave carrier frequencies below 6 GHz.

34. The apparatus of claim 23, wherein the LOS band comprises carrier frequencies greater than 6 GHz.

35. A computer program product for wirelessly communicating at a multi-mode wireless modem, comprising:
a computer-readable storage device comprising computer-readable program code stored thereon, the computer-readable program code comprising:
computer-readable program code configured to cause at least one processor to select a single carrier wireless channel from one of a line of sight (LOS) band or a non-line of sight (NLOS) band for receiving an incoming cyclically prefixed single carrier signal, wherein the multi-mode wireless modem is capable of receiving signals over both the LOS band and the NLOS band;
computer-readable program code configured to cause the at least one processor to select a cyclic prefix length associated with the incoming single carrier signal for a tunable cyclic prefix module of the multi-mode wireless modem based on an estimated delay spread of the selected wireless channel;
computer-readable program code configured to cause the at least one processor to identify and remove a cyclic prefix of the cyclic prefix length from the incoming single carrier signal; and
computer-readable program code configured to cause the at least one processor to perform frequency domain equalization on the incoming single carrier signal following the removal of the cyclic prefix.
